(19) United States
(12) Patent Application Publication
(10) Pub. No.: US 2016/0270521 A1
(43) Pub. Date: Sep. 22, 2016

(54) Blow Molding Panel with Strengthened Edge and Folding Table Applying Same

(71) Applicant: Yixiang JIANG, Zhejiang (CN)

(72) Inventor: Yixiang Jiang, Yuyao (CN)

(21) Appl. No.: 14/893,429

(22) PCT Filed: Aug. 12, 2013
(86) PCT No.: PCT/CN2013/000946

§ 371 Date: Jan. 14, 2016

(30) Foreign Application Priority Data
May 23, 2013 (CN) 201310195287.3

(51) Int. Cl. A47B 3/08; A47B 3/091; A47B 13/08

(52) U.S. Cl. CPC A47B 3/08; A47B 13/08; A47B 3/091; A47B 2003/0821; A47B 2003/0827; B29C 49/0031

(57) ABSTRACT

A blow-molded panel with reinforced edges and a folding table. A flange is extended downward on the periphery of the panel and surrounding the reinforced edge. The flange includes an inner flange layer and an outer flange layer. A hollow space is formed between the upper portion of the inner flange layer and the upper curvy portion of the outer flange layer, and the lower portion of the inner flange layer is attached to the lower straight portion of the outer flange layer. The flange has two layers, and the lower portion of the inner flange layer is attached to the lower straight portion of the outer flange layer, so that the firmness and the shock resistance of the fragile parts on the periphery of the panel are remarkably improved.

### RELATE APPLICATIONS

This application is a national phase entrance of and claims benefit to PCT Application for a blow-molded panel with reinforced edges and a folding table, PCT/CN2013/000946, filed on Aug. 12, 2013, which claims benefit to Chinese Patent Application 201310195287.3, filed on May 23, 2013. The specifications of both applications are incorporated here by this reference.

### FIELD OF THE INVENTION

The present invention relates to a panel and a folding table thereof, in particular to a blow-molded panel with reinforced edges and a folding table.

### DESCRIPTION OF THE PRIOR ART

Blow-molded products have the advantages of light weight due to their hollow structure, as well as high rigidity, good shock resistance, difficult to damage and the like due to their material, shape and structure. Recently, blow-molded products have been widely applied in a number of fields. For example, there are various blow-molded tables, blow-molded chairs, blow-molded stools and the like, as outdoor furniture articles.

Now, taking a blow-molded table as example, such a blow-molded table is usually formed from a blow-molded panel and a folding iron support, and numerous recessed support touch points, which are irregularly arranged and are of different shapes and sizes, are generally distributed on the bottom of the blow-molded panel for purpose of enhancing its strength. However, due to the limitations of the blow molding process, the panel often has some potential fault points to be easily damaged. For example, the material at the recessed support touch points becomes thinner after being stretched, particularly the edges (particularly corners) of the panel is relatively thin and soft, and thus these parts are likely to crack. To overcome the above problem, it is often to increase the thickness of the panel to enhance its structural strength. However, with the use of a thickened panel, the panel appears relatively thick and heavy. Accordingly, a blow-molded table having a thickened panel is heavy, and also not favor of saving cost. Moreover, even though a thickened panel is used, it is also unable to improve the rigidity and structural strength of the edges of the panel if no improvement is given to the structure of edges.

### SUMMARY OF THE INVENTION

A first technical problem to be solved by the present invention is to provide a blow-molded panel with reinforced edges, which has novel structure and sufficiently rigid and strong edges.

A second technical problem to be solved by the present invention is to provide a folding table using a blow-molded panel with reinforced edges. The blow-molded panel has novel structure and sufficiently rigid and strong edges.

To solve the first technical problem, the blow-molded panel with a reinforced edge, comprises a front side, a back side, and a flange extending downward on the periphery of the panel and surrounding the reinforced edge, the flange comprises: an inner flange layer having an upper portion, a lower portion and a step between these two portions; an outer flange layer having an upper curvy portion and a lower straight portion; wherein, a hollow space is formed between the upper portion of the inner flange layer and the upper curvy portion of the outer flange layer, and the lower portion of the inner flange layer is attached to the lower straight portion of the outer flange layer.

Preferably, height of a lower portion of the flange formed by attaching the lower portion of the inner flange layer to the lower straight portion of the outer flange layer is between ⅕ to ¼ of an overall height of the flange. Therefore, such design can ensure the strength of the flange, and can also be benefit for the mounting of the longitudinal beams.

To enhance the strength of the blow-molded panel and reduce the distortion resistance of the panel, the panel further comprises a number of recessed support touch points distributed on the back side of the panel.

Preferably, each support touch point has a strip-shape, with two reinforcing ribs placed between three contact points, each reinforcing rib is surrounded by two contact points. Therefore, such design can enhance the strength of the support touch point and reduce the distortion resistance of the panel, and also decrease the area of the contact points, and prevent the surface of the panel from having scars and thus improve the flatness of the surface of the panel.

To enhance the strength at the corners of the panel, the panel has four corners, each corner has a corner support touch point with a linear inner side and an arc outer side. Preferably, two or more slant reinforcing ribs may be provided within each of the corner support touch points.

Preferably, two first strip-shaped grooves adjacent to the flange and disposed on two opposite sides of the back side of the panel; and two second strip-shaped grooves are respectively provided between two opposite ends of the two first strip-shaped grooves, wherein the support touch points within both the first strip-shaped grooves and the second strip-shaped grooves are placed horizontally or vertically and separated from each other. The first strip-shaped grooves and the second strip-shaped grooves are used for installing longitudinal beams and cross beams, respectively, and the support touch points within both the first strip-shaped grooves and the second strip-shaped grooves may further improve the rigidity and strength of the panel.

To be convenient for the folding of a foot stool of a folding table mated with the panel, a plurality of third strip-shaped grooves disposed within a region enclosed by the first strip-shaped grooves and the second strip-shaped grooves on the back side of the panel, and the support touch points within the third strip-shaped grooves are placed horizontally or vertically separated from each other; and a set of foots attached to the panel and embedded into the third strip-shaped grooves after folded. The support touch points within the strip-shaped grooves further improve the rigidity and strength of the panel.

To solve the second technical problem, the folding table using the blow-molded panel comprises two longitudinal beams, each longitudinal beam being embedded into a first strip-shaped groove of the panel and fixed to an upper portion of an inner flange layer of a flange; two cross beams, each cross beam being embedded into a second strip-shaped groove and two ends of each cross beam are connected to the two longitudinal beam; and a set of foots mounted on the two cross beams, and the set of foots is embedded into third strip-shaped grooves after folded. Under this design, the folding table is relatively firm in structure and easy to be folded.

The longitudinal beams mounted within the first strip-shaped grooves may adopt various structures. Preferably, each longitudinal beam has a L-shaped cross-section, which includes a vertical portion embedded into the first strip-shaped grooves and a transverse portion disposed on the step of the inner flange layer, an end of the transverse portion of each longitudinal beam touches the inner surface of the lower portion of the inner flange layer. When the folding table is stacked, the longitudinal beams embedded into the first strip-shaped grooves may effectively improve the shock resistance of the flange.

To be easier to stack folding tables when folded, the bottom surface of each longitudinal beam is flush with a bottom surface of the flange.

Compared with the prior art, in the present invention, firstly, the flange of the hollow blow-molded panel has two layers, and the lower portion of the inner flange layer is attached to the lower straight portion of the outer flange layer, so that the firmness and the shock resistance of the fragile parts on the periphery of the panel are remarkably improved, and such design is novel; secondly, due to the first strip-shaped grooves, the second strip-shaped grooves and the strip-shaped grooves respectively formed in the back side of the panel, the set of foots can be conveniently and firmly installed, a high flatness can be kept after the panel and the set of foots are completely folded, and a plurality of folding tables can be easily stacked up after being folded accordingly.

### BRIEF DESCRIPTION OF THE DRAWINGS

FIG. 1 is a perspective view of a panel according to an embodiment of the present invention;

FIG. 2 is a plan view of the panel of FIG. 1;

FIG. 3 is a partially enlarged sectional view of FIG. 2 in direction of B-B;

FIG. 4 is a partially enlarged view of part-A in FIG. 2;

FIG. 5 is a perspective view of a folding table with the panel according to the embodiment of the present invention (with the set of foots unfolded);

FIG. 6 is a perspective view of a folding table with the panel according to the embodiment of the present invention (with the set of foots folded);

FIG. 7 is a partially enlarged sectional view of FIG. 6 in direction of C-C.

### DETAILED DESCRIPTION OF THE PREFERRED EMBODIMENT

To enable a further understanding of the innovative and technological content of the invention herein, refer to the detailed description of the invention and the accompanying drawings below:

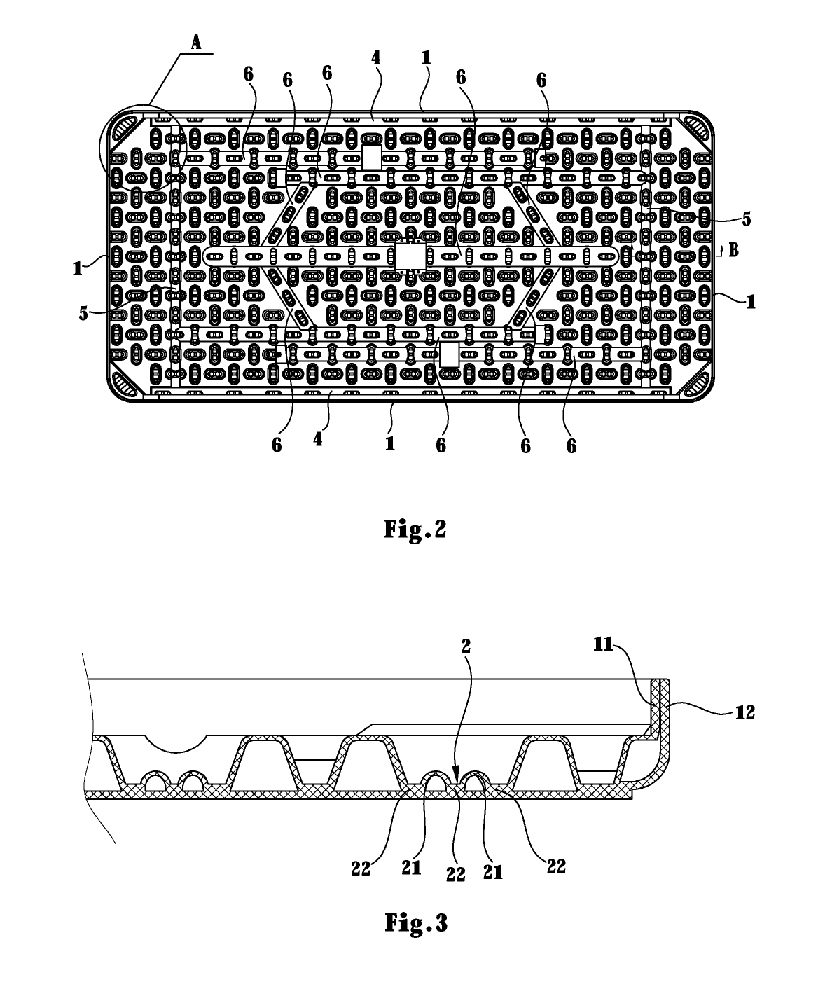

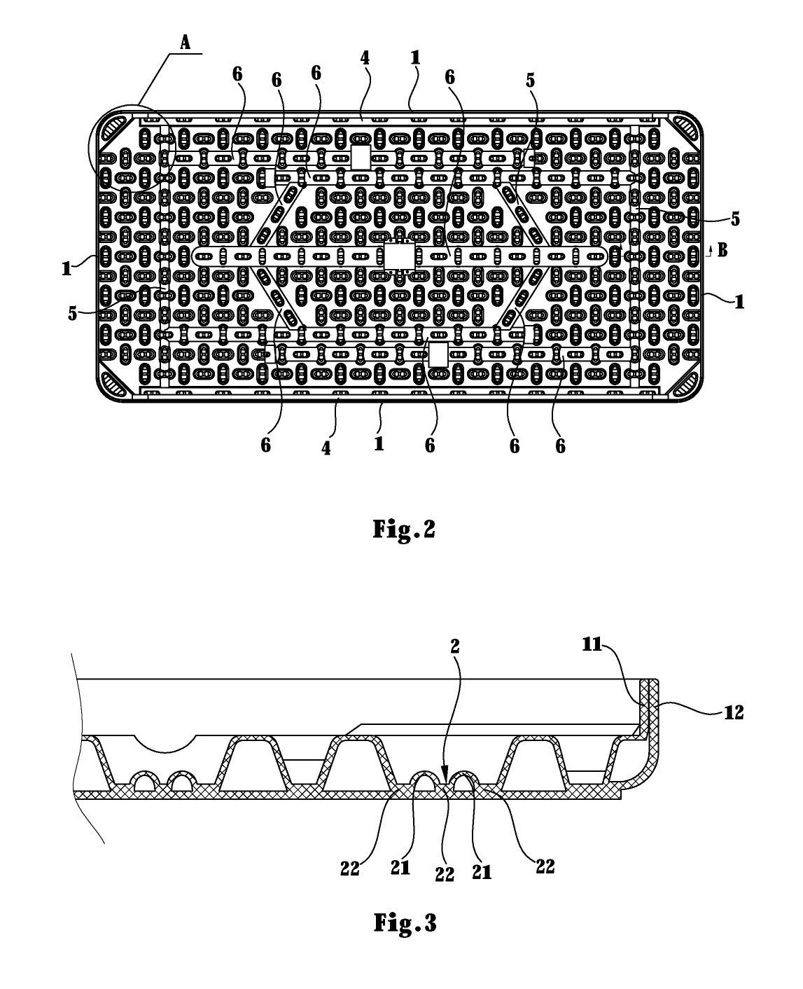

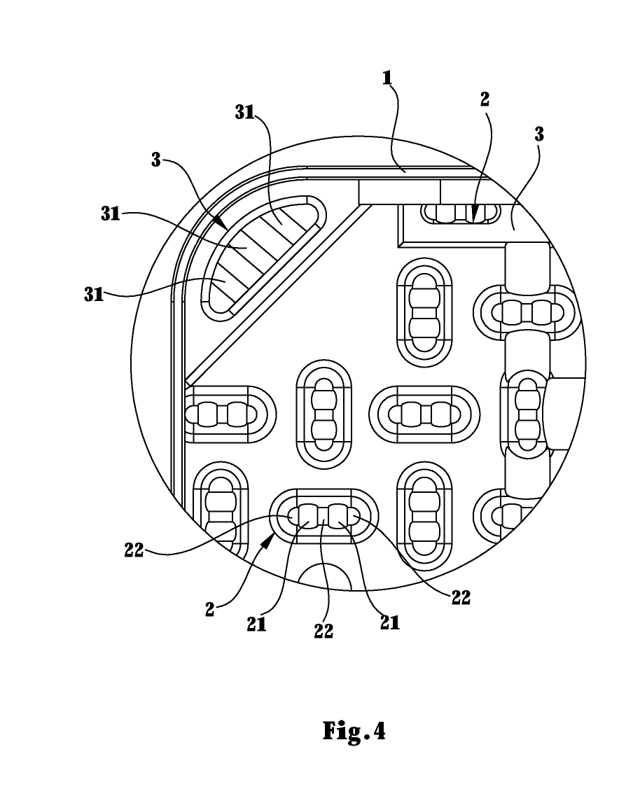

FIG. 1-FIG. 4 show a preferred embodiment of the panel of the present invention. A number of recessed support touch points 2 are distributed crisscross on a back side of a blow-molded panel, and the support touch points 2 are strip-shaped. The crisscross arrangement of the support touch points 2, by the cross mechanics principle, an external stress in one direction can effectively be decomposed into multiple forces in different directions being held with each other, therefore, the firmness and the distortion resistance of the panel are improved. Furthermore, under the design of the recessed support touch points 2, the wall thickness of the blow-molded panel can be reduced, and the weight of the panel can be reduced accordingly. Particularly, for an ultra-thin (thickness<40 MM) panel, under the design of the crisscross support touch points 2, the firmness of the panel can be enhanced greatly, so that it is less likely to deform. In addition, in order to improve the strength of the support touch points 2, two reinforcing ribs 21 and three touch points 22 are placed in each support touch point 2, two reinforcing ribs 21 placed between three contact points 22, each reinforcing rib 21 is surrounded by two contact points 22. So that, the area of the touch points 22 is reduced, and it is not easy to result in scars on the front face of the panel. Therefore, the flatness of the surface of the panel can be improved, and the distortion of the panel can be reduced. Of course, depending upon the specific arrangement of the support touch points 2, it is also allowable that only one reinforcing rib 21 or more than two reinforcing ribs 21 are provided within a certain support touch point 2.

To enhance the strength at the corners of the panel, the panel has four corners, each corner has a corner support touch point 3 with a linear inner side and an arc outer side. Furthermore, to further improve the strength of the corner support touch points, in this embodiment, three slant reinforcing ribs 31 are provided within each of the corner support touch points 3.

Similarly to a conventional panel, a flange 1 is extended downward on the periphery of the panel and surrounding the reinforced edge. As the periphery of the blow-molded panel is easy to be damaged, to ensure its firmness and shock resistance, in this embodiment, the flange 1 comprises an inner flange layer 11 and an outer flange layer 12. The inner flange layer 11 has an upper portion, a lower portion and a step between these two portions, and the outer flange layer 12 has an upper curvy portion and a lower straight portion. A hollow space is formed between the upper portion of the inner flange layer 11 and the upper curvy portion of the outer flange layer 12, and the lower portion of the inner flange layer 11 is attached to the lower straight portion of the outer flange layer 12. Specifically, the upper portion of the inner flange layer 11 has a distance with the upper curvy portion of the outer flange layer 12, the middle of the inner flange layer 11 bent toward the outer flange layer 12 and the step is formed between the upper portion and the lower portion of the inner flange layer 11, and the lower portion of the inner flange layer 11 is attached to the lower straight portion of the outer flange layer 12. Preferably, the height of a lower portion of the flange 1 formed by attaching the lower portion of the inner flange layer 11 to the lower straight portion of the outer flange layer 12 is between ⅕ to ¼ of an overall height of the flange 1. Therefore, such design can ensure the strength of the flange, and can also be benefit for the mounting of the longitudinal beams.

Two first strip-shaped grooves 4 adjacent to the flange 1 and disposed on two opposite sides of the back side of the panel 1; and two second strip-shaped grooves 5 are respectively provided between two opposite ends of the two first strip-shaped grooves 4, wherein the support touch points 2 within both the first strip-shaped grooves 4 and the second strip-shaped grooves 5 are placed horizontally or vertically and separated from each other. A plurality of third strip-shaped grooves 6 disposed within a region enclosed by the first strip-shaped grooves 4 and the second strip-shaped grooves 5 on the back side of the panel 1, and the support touch points 2 within the third strip-shaped grooves 6 are placed horizontally or vertically separated from each other; and a set of foots 9 attached to the panel and embedded into the third strip-shaped grooves 6 after folded.

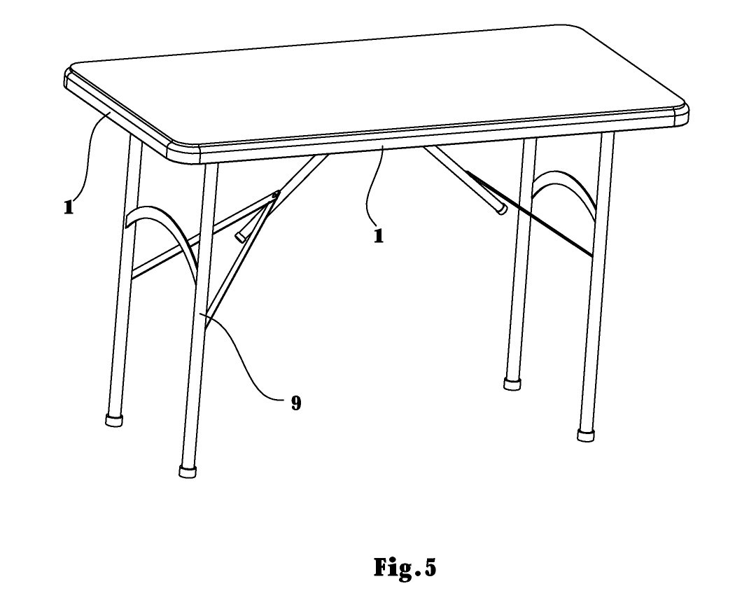

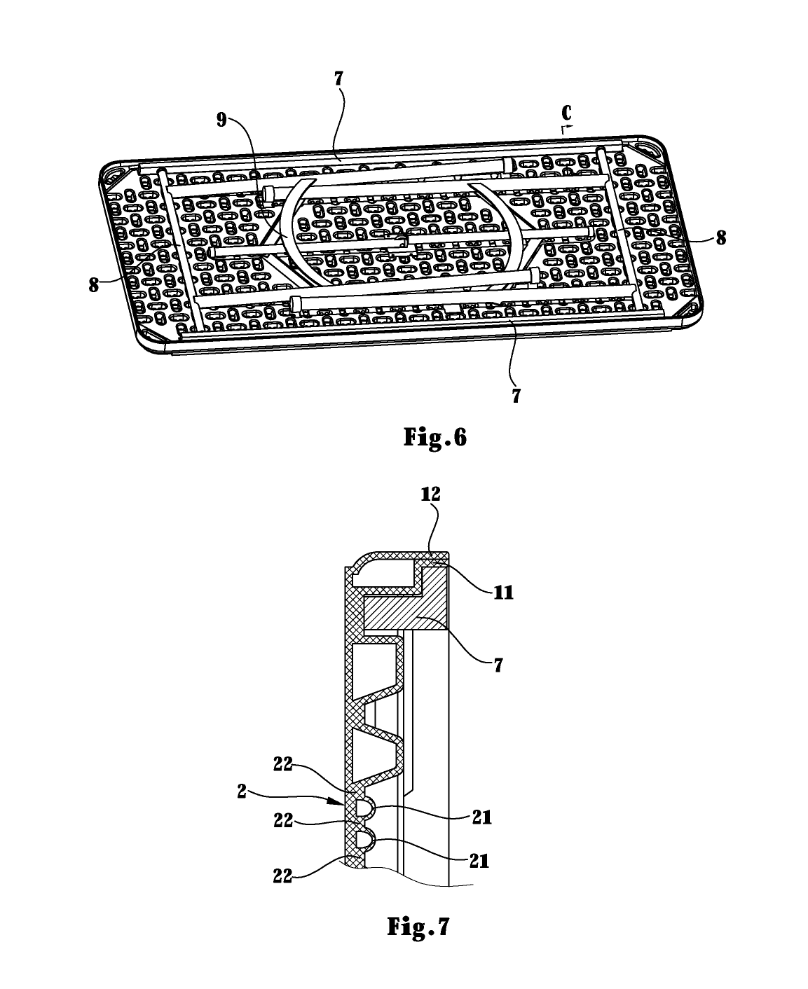

FIG. 5-FIG. 7 show a preferred embodiment of the folding table with the above stated panel of the present invention. The folding table with the blow-molded panel, comprises two longitudinal beams 7, each longitudinal beam being embedded into a first strip-shaped groove 4 of the panel 1 and fixed to an upper portion of an inner flange layer 11 of a flange 1; two cross beams 8, each cross beam being embedded into a second strip-shaped groove 5 and two ends of each cross beam 8 are connected to the two longitudinal beam 7; and a set of foots 9 mounted on the two cross beams 8, and the set of foots 9 is embedded into third strip-shaped grooves 6 after folded. The movably folding foot stool is substantially the same as the set of foots structure of an existing stable stand, and will not be repeated here. High flatness can be kept after the panel and the foot stool are completely folded, and a plurality of folding tables can be easily stacked after being folded accordingly. In addition, to further improve the shock resistance of the flange 1, each longitudinal beam 7 has a L-shaped cross-section, which includes a vertical portion 71 embedded into the first strip-shaped grooves 4 and a transverse portion 72 disposed on the step of the inner flange layer 11, an end of the transverse portion 72 of each longitudinal beam 7 touches the inner surface of the lower portion of the inner flange layer 11, and the bottom surface 73 of each longitudinal beam 7 is flush with a bottom surface of the flange 1.

In accordance with the provisions of the patent statutes, the present invention has been described in what is considered to represent its preferred embodiment. However, it should be noted that the invention can be practiced otherwise than as specifically illustrated and described without departing from its spirit or scope.

1. A blow-molded panel with a reinforced edge, comprising a front side, a back side, and a flange extending downward on the periphery of the panel and surrounding the reinforced edge, the flange comprising:
an inner flange layer having an upper portion, a lower portion and a step between these two portions;
an outer flange layer having an upper curvy portion and a lower straight portion;
wherein, a hollow space is formed between the upper portion of the inner flange layer and the upper curvy portion of the outer flange layer, and the lower portion of the inner flange layer is attached to the lower straight portion of the outer flange layer.

2. The panel of claim 1, wherein height of a lower portion of the flange formed by attaching the lower portion of the inner flange layer to the lower straight portion of the outer flange layer is between ⅕ to ¼ of an overall height of the flange.

3. The panel of claim 1, further comprising a number of recessed support touch points distributed on the back side of the panel.

4. The panel of claim 3, wherein each support touch point has a strip-shape, with two reinforcing ribs placed between three contact points, each reinforcing rib is surrounded by two contact points.

5. The panel of claim 1, wherein the panel has four corners, each corner has a corner support touch point with a linear inner side and an arc outer side.

6. The panel of claim 1, further comprising:
two first strip-shaped grooves adjacent to the flange and disposed on two opposite sides of the back side of the panel; and
two second strip-shaped grooves are respectively provided between two opposite ends of the two first strip-shaped grooves,
wherein the support touch points within both the first strip-shaped grooves and the second strip-shaped grooves are placed horizontally or vertically and separated from each other.

7. The panel of claim 6, further comprising:
a plurality of third strip-shaped grooves disposed within a region enclosed by the first strip-shaped grooves and the second strip-shaped grooves on the back side of the panel, and the support touch points within the third strip-shaped grooves are placed horizontally or vertically separated from each other; and
a set of foots attached to the panel and embedded into the third strip-shaped grooves after folded.

8. A folding table using the blow-molded panel of claim 1, comprising:
two longitudinal beams, each longitudinal beam being embedded into a first strip-shaped groove of the panel and fixed to an upper portion of an inner flange layer of a flange;
two cross beams, each cross beam being embedded into a second strip-shaped groove and two ends of each cross beam are connected to the two longitudinal beam; and
a set of foots mounted on the two cross beams, and the set of foots is embedded into third strip-shaped grooves after folded.

9. The folding table of claim 8, wherein each longitudinal beam has a L-shaped cross-section, which includes a vertical portion embedded into the first strip-shaped grooves and a transverse portion disposed on the step of the inner flange layer, an end of the transverse portion of each longitudinal beam touches the inner surface of the lower portion of the inner flange layer.

10. The folding table of claim 9, wherein the bottom surface of each longitudinal beam is flush with a bottom surface of the flange.
